(19) United States
(12) Patent Application Publication
(10) Pub. No.: US 2002/0133505 A1
(43) Pub. Date: Sep. 19, 2002

(54) System for recommending crops and attachments to farm tractors

(76) Inventor: Hideki Kuji, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/081,151

(22) Filed: Feb. 25, 2002

(30) Foreign Application Priority Data
Mar. 14, 2001 (JP) 2001-072723
Mar. 21, 2001 (JP) 2001-081241
Mar. 21, 2001 (JP) 2001-081242
Mar. 23, 2001 (JP) 2001-085896
Mar. 27, 2001 (JP) 2001-089524

(51) Int. Cl. G06F 7/00

(52) U.S. Cl. 707/104.1

(57) ABSTRACT

A system is provided that comprises a crop database for storing information on the crops that are appropriate for cultivation in terms of cultivation areas and cultivation seasons and a server for providing over the Internet a web site that is associated with the crop database. In response to a user's access the web site, the server transmits an input form to the user so as to allow the user to input the user's crop cultivation area and the cultivation season in the input form. The server retrieves crop information from the crop database based on the information in the filled-in input form transmitted back from the user, and to transmit retrieved crop information to the user. The system may comprise a farm tractor database for storing information on farm tractors that are appropriate for crops to be cultivated as well as information on attachments to be mounted on these farm tractors. The system includes a server for providing over the Internet a web site that is associated with the farm tractor database. In response to a user's access the web site, the server transmits to the user a page including farm tractor information retrieved from the farm tractor database and a linked button. When the user moves a cursor onto the button and clicks it, that event is transmitted to the server. The server retrieves information on the attachments from the farm tractor database and transmits retrieved information to the user.

### BACKGROUND OF THE INVENTION

1. Technical Field

The invention relates to a system for identifying and recommending optimal crops and providing information regarding small-size farm tractors based on information on cultivation locality input by users. The invention also relates to a system for assisting cultivation of crops by providing information about the price of the crops, weather forecast and so on.

2. Description of the Related Art

In recent years, there is an increasing tendency that non-farmers engage in cultivation of such crops as vegetables and fruits around their homes. In general, these people do not have sufficient knowledge about the crops, so they often have difficulty in selecting appropriate crops to cultivate. Besides, small-size cultivating machines or farm tractors are often used even for such personal cultivation.

Recently, the ratio of dedicated farmers to the entire agriculture practitioners is decreasing. In contrast, farmers who have additional jobs are increasing, or quite a few people who used to live in urban area tend to move to rural area to engage in agriculture. These people are generally poor in terms of obtaining market information and have difficulty in establishing an appropriate revenue/expenditure plan for cultivating crops. Besides, new corners into the agriculture generally lack knowledge regarding the weather and the characteristics of the soil in their local area as well as knowledge about agricultural machines, so they have difficulties in selecting appropriate crops or purchasing appropriate agricultural machines.

Quite often, the location of a store where a user purchases an agricultural machine is relatively far from the location where the purchased machine is actually used. In such cases, when the user requests a repairing service through the store for a machine in trouble, a repairing service person may be dispatched from a remote repairing service center. This may incur an extra cost due to the cost of trip by the service person. Accordingly, it would be advantageous for a user if it buys an insurance with a certain insurance premium for receiving a lower-cost or free repairing service provided by a service center that may dispatch a service person from a remote place (such insurance will be referred to as repairing insurance hereinafter).

Furthermore, because most books describe only about cultivation time (season) and/or cultivation method appropriate in general for each crop, users tend to select crops without considering about such characteristics as the weather, soil property or altitude of the location where the selected crop is cultivated by the user. These characteristics need to be taken into account in order to cultivate the crops. Without such factors taken into consideration, people cannot expect a good harvest.

Thus, there is a need for simple means for enabling people to select crops with appropriate consideration about such characteristics as cultivation locality.

Besides, as for small-size farm tractors, one unit of farm tractor is typically designed so as to cope with various crops and cultivating works. Accordingly, a variety of attachments are available for use with small-size farm tractors. However, it is difficult for the person having no professional knowledge to determine which attachment is appropriate for cultivating crops.

Thus, there is another need for a system for enabling users of small-size farm tractor to know about appropriate attachments.

There is also a need for means by which users can comprehensively examine such items as market price of certain crops, selection of certain crops appropriate to the cultivation area, selection of required cultivating machines.

Over the Internet, there are many web sites of virtual stores dealing with varieties of business. However, those web sites only provide information in one-way manner from the web side to the user side. Thus, users could only refer to given information in deciding about purchasing or engaging in a contract. In many cases, users face difficulty in obtaining information including quality and/or reliability of the products. Besides, in many web sites, such information about how to use the purchased product and/or the after-service is not provided. Therefore, the user satisfaction with such virtual store web sites is often lower than that when users purchase products at real stores.

Furthermore, when a user who has poor knowledge on the Internet, he or she may not be able to handle the process for purchasing products from the web site, and accordingly may miss a chance for purchasing the product he or she wants to get.

### SUMMARY OF THE INVENTION

A system according to a first aspect of the invention comprises a crop database for storing information on the crops that are appropriate for cultivation in terms of cultivation areas and cultivation seasons and a server for providing over the Internet a web site that is associated with the crop database. In response to a user's access the web site, the server transmits an input form to the user so as to allow the user to input the user's crop cultivation area and the cultivation season in the input form. The server retrieves crop information from the crop database based on the information in the filled-in input form transmitted back from the user, and to transmit retrieved crop information to the user.

In accordance with the invention, the user can easily know, through the browser at the user's terminal, the crops and the related cultivation method appropriate to the user's cultivation area and cultivation season. The user may not have professional knowledge.

In a variation of the first aspect of the invention, the system further comprises a soil database for storing information about soil characteristics soil improvement method for each area. Besides, the server retrieves information about soil characteristics and soil improvement method from the soil database based on the information in the filled-in input form transmitted back from the user, and to transmit the retrieved soil information together with the crop information to the user.

In accordance with the invention, the user can easily get, through the browser at the user's terminal, information about soil characteristics and soil improvement method for the user's cultivation place. Thus, the user can utilize such information in selecting crops to cultivate and would be able to increase harvest amount of the crops by improving the soil in the user's cultivation place.

In accordance with another aspect of the invention, the system further comprises a map database for storing map images for each area together with information on latitudes/longitudes. The server retrieves from the map database a map image covering the user's crop cultivation area that is identified by the information included in the filled-in input form transmitted back from the user. The server transmits the retrieved map image to the user. When the user moves a cursor onto a desired place on the map and clicks it, that event is transmitted to the server. Upon receiving that event, the server reads out the latitude/longitude information of the concerned place from the map database, and searches through the crop database and the soil database based on that latitude/longitude information.

In accordance with the invention, the user can select the user's cultivation place on the map image displayed in the browser at the user's terminal by moving the cursor on the screen with a mouse and clicking it. Thus, the user could obtain further segmented information on the crop and the soil.

In a further aspect of the invention, the system comprises a map database for storing images of railroad maps for each area together with information on latitudes/longitudes for stations included in the railroad maps. The server retrieves from the map database a railroad map image covering the user's cultivation area that is identified by the information included in the filled-in input form transmitted back from the user. The server transmits the retrieved railroad map image to the user. When the user moves a cursor onto a station on the railroad map image and clicks it, that event is transmitted to the server. The server is configured, responsive to receiving that event, to read out the latitude/longitude information of the concerned station from the map database and to search through the crop database and the soil database based on that latitude/longitude information.

A system according to yet another aspect of the invention comprises a farm tractor database for storing information on farm tractors that are appropriate for crops to be cultivated as well as information on attachments to be mounted on these farm tractors. The system also comprises a server for providing over the Internet a web site that is associated with the farm tractor database. In response to a user's access the web site, the server transmits to the user a page for displaying the farm tractor information retrieved from the farm tractor database and also for displaying a button having a link capability. When the user moves a cursor onto the button and clicks it, that event is transmitted to the server. The server retrieves information on the attachments from the farm tractor database in response to receiving that event and then transmits retrieved information to the user.

In accordance with this aspect of the invention, the user can learn not only a combination of a farm tractor and the attachments to be used for crop cultivation but also how to use such a farm tractor and attachments without professional knowledge.

A system according to further aspect of the invention comprises a market database for storing information on historical price and shipment volume regarding crops, and a server for providing over the Internet a page, which is associated with the market database, for allowing selection of crop names. The server transmits the page to a user in response to the user's access. An event of the user's clicking operation upon a crop name being displayed on the page is transmitted to the server. In response to that event, the server searches in the market database and transmits to the user information on historical price and shipment volume of the selected crop in the form of HTML document.

In accordance with this aspect of the invention, the user can utilize the user's home terminal to easily obtain the information about product price and shipment volume. Thus, the user can make a revenue/expenditure plan for cultivating crops.

In a variation of this aspect of the invention, the system further comprises a weather forecast database for storing information on long-term weather forecast. The server searches in the market database in response to an event that the user clicks upon a crop name. The server transmits information on historical price and shipment volume of the selected crop to the user in a form of HTML document. In accordance with this variation of the invention, the user can utilize the user's home terminal to easily obtain information about a long-term weather forecast, which is helpful for the crop cultivation.

A system according to another aspect of the invention comprises a database regarding repair centers for agricultural machines and a server for providing over the Internet a page regarding the repair centers. In response to a user's access the page, the server transmits to the user a first input form for allowing the user to input a location where an agricultural machine owned by the user is located. The server is configured to retrieve information on the repair center that is located closest, in terms of distance, to the location of the user machine based on the location information identified in the first input form transmitted back from the user. The server transmits to the user HTML document containing information on the repair center and information on repairing insurance.

In accordance with this aspect of the invention, the user can easily find out on-line the repair center that is closest to the place where the user's agricultural machine is located.

A system according to yet another aspect of the invention comprises a user terminal having an Internet telephone capability and a business entity operator terminal having the Internet telephone capability. The system further comprises a server that provides over the Internet a virtual store web site including a button for establishing a communication between the user and the business entity operator by using the Internet telephone capability. The system includes storage for a first database for storing information on the user and a second database for storing information on the telephone number of the business entity operator terminal. The server is configured to retrieve the telephone number information of the business entity operator terminal from the second database in response to the user's operation of clicking the button after the user has accessed the web site through the user terminal. The server then transmits the retrieved telephone number information to the user terminal. The user terminal is configured to use the Internet telephone capability to make a telephone call to such transmitted telephone number.

In accordance with this aspect of the invention, the user can receive the verbal explanation about the commodity from a store person while viewing the information displayed on the display screen, and accordingly the user can understand the commodity much better. The information displayed in the virtual store is not limited to commodities. If the displayed commodities are, for example, agricultural machines, the information on method for utilizing agricultural machines which may include crop cultivation method can be displayed together with information on the insurance for repairing the agricultural machines.

In a variation of this aspect of the invention, the web site further comprises a second button for allowing the user to make a telephone call again to the same business entity operator to whom the user has called using the Internet telephone capability when the user has previously accessed the web site. The first database stores the transmitted telephone number information in association with the user, and accordingly the server is configured to retrieve from the first database the telephone number information of the business entity operator terminal that is associated with the user in response to the user's operation of clicking the second button after the user has accessed to the web site through the user terminal. The server transmits the retrieved telephone number information to the user terminal.

In accordance with the variation of this aspect of the invention, the user would feel comfortable because the user can always and consistently get the reception of the same operator whenever the user accesses the virtual store. Besides, the user can obtain the almost same satisfaction as when the user might visit a real store.

### BRIEF DESCRIPTION OF THE DRAWINGS

FIG. 1 is a general block diagram of a system structure according to one embodiment of the invention.

FIG. 2 shows an exemplary input form in the crop recommendation web site.

FIG. 3 shows an exemplary page for displaying recommended crops.

FIG. 4 shows an example of the cultivation support page.

FIG. 5 shows an example of the soil information page.

FIG. 6 shows an example of the farm tractor introduction page.

FIG. 7 shows an example of the attachment selection page.

FIG. 8 shows an example of the purchase information input form.

FIG. 9 is a general block diagram of a system structure according to another embodiment of the invention.

FIG. 10 shows an example of the agriculture product market information page.

FIG. 11 shows the agriculture product market information page after the farm product has been selected.

FIG. 12 is a general block diagram of a system structure according to a further embodiment of the invention.

FIG. 13 shows an example of the user information input form.

FIG. 14 is an example of the repair center information page.

FIG. 15 is a general block diagram of a system structure according to yet another embodiment of the invention.

FIG. 16 shows an example of the virtual store web site.

FIG. 17 shows an example of the commodity introduction page.

FIG. 18 shows an example of the user registration form.

FIG. 19 shows an example of the user ID input form.

FIG. 20 shows an example of the display of the Internet telephone software.

FIG. 21 shows an example of the user registration.

FIG. 22 shows an example of the store introduction page.

### DESCRIPTION OF THE PREFERRED EMBODIMENTS

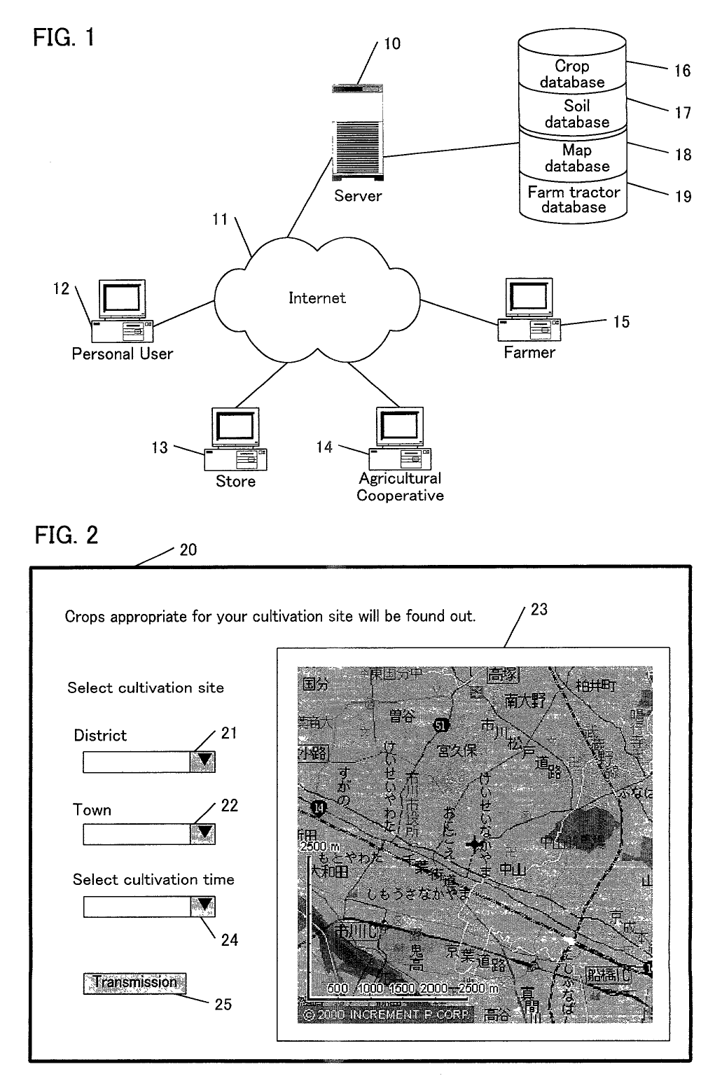

Referring now to the drawings, preferred embodiments of the invention will be described. FIG. 1 is a general block diagram of a system structure according to one embodiment of the invention. Server 10 is a computer connected to Internet 11 and is configured to provide a crop recommendation web site for providing information about recommended cultivation crops over the network. Terminals 12, 13, 14, 15 are installed respectively at such user places as homes, agricultural machine stores, farmer cooperatives, farmers etc. Each terminal comprises a display enabling the GUI environment as well as such input device as mouse. Each of the terminals 12, 13, 14, 15 can be a personal computer and is installed with a browser such as Microsoft Internet Explorer (trademark) that is set up to connect to the Internet 11. The personal computer can access the crop recommendation web site provided by the server 10 by entering the URL of the web site. A user, who wants to know about crops that are appropriate to the user's cultivation place, can access the crop recommendation web site using the browser in the user's personal computer.

To the server 10, a crop database 16, a soil database 17, a map database and a farm tractor (cultivating machine) database 19 are connected. In response to a user's access to the crop recommendation web site, the server 10 transmits to the user an input form, which is an HTML document. The user fills the information in the form and transmits it to the serever 10. Then, the server 10 searches each database based on the transmitted information and transmit the retrieved information to the user.

The crop database 16 includes information about the crops and how to cultivate the crops in association with local areas and the cultivatable time (season). The crops in the crop database 16 are pre-selected as appropriate for cultivation in terms of the local weather, the soil and the altitude of the respective areas. The areas can be divided into smaller areas with recommended crops that are appropriate for each of such divided areas.

In the crop database 16, the extent of each area is defined by the latitude/longitude. The crop database 16 is configured such that the user can utilize the latitude/longitude information for the place the user selects on the browser in order to search the area covering the user-selected place. This operation will be later explained in detail. The crop database 16 additionally stores image files for each crop in association with crop names.

In the soil database 17, soil characteristics for each area are stored beforehand. When the areas to be stored in the soil database 17 are segmented in smaller areas, it is possible to store more specific soil characteristics for the segmented areas.

In the soil database 17, the extent of each area is defined by the latitude/longitude. In the same manner as in the crop database 16, the soil database 17 is configured such that the user can utilize the latitude/longitude information for the place the user selects on the browser in order to search the area covering the user-selected place. This operation will be later explained in detail. The soil database 17 additionally stores information on soil improvement methods in association with the soil characteristics.

The map database 18 stores map image files for the areas corresponding to towns throughout the country. In addition, the map database 18 stores the latitude/longitude and the altitude corresponding to each of the coordinates that are set for each map image.

The farm tractor database 19 stores beforehand information about farm tractors and their attachments as appropriate for particular crops or works, information about their prices, and respective forms for users to input information. In particular, the information about farm tractors and their attachments is associated with image files representing their views. These image files are stored in the farm tractor database 19.

FIG. 2 illustrates an example of the input form 20 that is transmitted from the server 10 and displayed on the browser of the user terminal when the user makes an access the crop recommendation web site through the use of the browser at the user terminal. The input form 20 comprises a district pull-down menu 21 and a town pull-down menu 22 for selecting a cultivation place where the user wants to cultivate specific crops, a cultivation time pull-down menu 24 for selecting when the user is going to start the crop cultivation, a field 23 for displaying a map image and a transmission button 25. When the user moves a pointer being displayed on the display screen onto the triangle mark on the right end of the district pull-down menu 21 and clicks thereon by means of such input device as mouse, a list of the district names is displayed beneath the district pull-down menu 21. Then, the user selects a specific district including the user cultivation place from the displayed list. After the district selection, the user clicks the triangle mark on the right end of the town pull-down menu 22 to display a list of the towns belonging to the above-selected district beneath the town pull-down menu. When the user clicks and selects a specific town covering the user cultivation place from the displayed list, information on that specific town name is transmitted from the user terminal to the server 10 in accordance with the HTTP protocol.

The server 10 retrieves from the map database 18 a map image file of the area corresponding to the transmitted town name and transmit it to the user terminal so as to be displayed in the field 23 of the input form 20. The user moves the pointer onto the point on the displayed map image corresponding to the cultivation place and then clicks there, so that the coordinate of that point on the map is transmitted from the user terminal to the server 10 according to the HTTP protocol. The server 10 retrieves the latitude/longitude corresponding to the transmitted coordinate from the map database 18. In this way, the user can select easily and in detail the user's own cultivation place on the map image displayed in the browser. Thus, the user can obtain the information about the recommended crops and the soil for the segmented area.

In another embodiment, the map database 18 stores image files for railroad maps by districts together with information on latitude/longitude and altitude of the places of railroad stations included in the railroad map images. In this embodiment, when the user selects a district from the district pull-down menu 21 in the input from 20 as aforementioned, information on the district name is transmitted from the user terminal to the server 10 according to the HTTP protocol. The server 10 retrieves the image file of the roadmap corresponding to the transmitted district name from the map database 18 and transmits it to the user terminal, which is displayed in the field 23 of the input form 20. If the user moves the pointer onto the station near to the cultivation place on the displayed roadmap image and clicks thereon, that event is transmitted from the user terminal to the server 10 according to the HTTP protocol, and in response, the server 10 retrieves from the map database 18 latitude/longitude and altitude of the place of the railroad station. In this embodiment, the user cannot obtain detailed information on latitude/longitude of the cultivation place. This embodiment may be used when users want to select cultivation places quickly and easily.

After having selected the cultivation place in FIG. 2, the user clicks the triangle mark on the right end of the cultivation time pull-down menu 24. Then, a calendar is displayed beneath the cultivation time pull-down menu 24. When the user clicks to select the month or date when the user wants to start cultivation in the displayed calendar and clicks the transmission button 25, information about the selected date is transmitted to the server 10.

The server 10 retrieves the crops appropriate for cultivation from the crop database 16 based on the transmitted cultivation start date and information on the already-retrieved latitude/longitude of the cultivation place. Specifically, the server 10 first uses the information on the latitude/longitude to retrieve the area including that latitude/longitude, and then retrieves the crops that are appropriate for the cultivation associated with the retrieved area. Subsequently, the server 10 selects, from the above-retrieved crops, crops having appropriate cultivation season that matches with the specified cultivation start date. The server then retrieves image files of such selected crops. When a plurality of crops are selected as appropriate crops to the identified cultivation place and start time, each of those crops will be given a respective priority based on the scores in accordance with a predetermined method. After all the operations have completed, the server 10 transmits the retrieved information and a page for displaying such information to the user terminal.

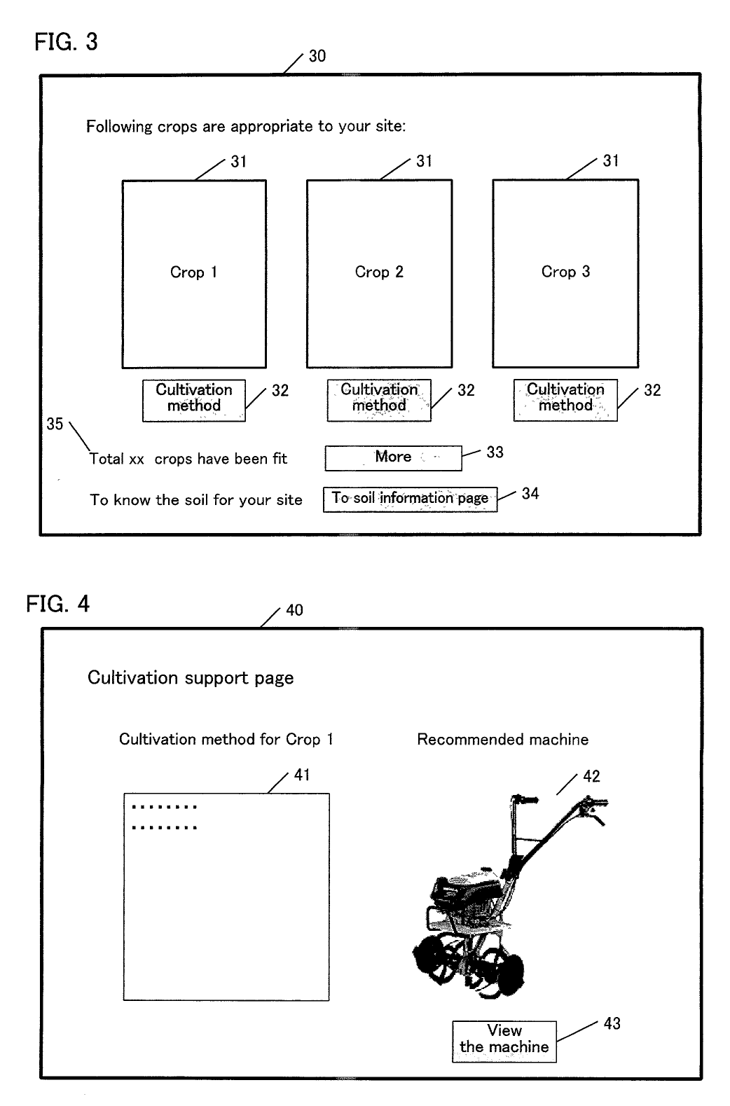

FIG. 3 illustrates an example of the page 30 for displaying recommended crops. The server 10 displays an image file or image files of at least one selected crop in the field(s) 31 of the page 30. When there are more than one crops selected, they are aligned from the left to the right in the sequence according to the determined priorities, and at the same time a message 35 of “total xx crops have been hit” is displayed. When all image files for the crops cannot be displayed in one display screen, as a button 33 is clicked, image files for the crops having the next highest priority may be displayed. By repeating such operation, the user could view the image files of all selected crops. The user may click a cultivation method button 32 that is provided below the image file for each crop to proceed to the cultivation support page in which the cultivation method for each crop is presented. Besides, a soil information button 34 is provided in the page 30, too. The user may click the soil information button 34 to proceed to the soil information page in which the soil characteristics in relation with the cultivation place is presented.

FIG. 4 illustrates an example of the cultivation support page 40. If the cultivation method button 32 is clicked in FIG. 3, the server retrieves information on the cultivation method for the corresponding crop from the crop database 16 and transmits it to the user terminal together with the page 40. The cultivation method for the crop is displayed in the field 41 of the page 40. The cultivation method includes a method appropriate to the weather as well as appropriate timing for cultivation/harvest to the concerned area, kinds of fertilizers and timing for feeding the fertilizers, materials and machines appropriate for seeding, weed-killing and cropping and how to use those materials and machines.

The crop database 16 may additionally store image files of the farm tractors appropriate for cultivating each of the crops in association with information on the cultivation method. In such way, when information on the crop cultivation method is retrieved, the associated image file is retrieved at the same time from the crop database 16, and then transmitted to the user terminal so as to be displayed in the field 42 of the page 40.

When the user wants to buy the displayed farm tractor or wants to get more detailed explanation about the displayed farm tractor, the user can move to a farm tractor introduction page (will be explained later) by means of clicking a button 43 displayed beneath the field 42.

Thus, the user could easily know the crops and the related cultivation methods appropriate to the cultivation place and the desired season without professional knowledge. Thus, the harvest amount of the crops could be increased through the proper cultivation.

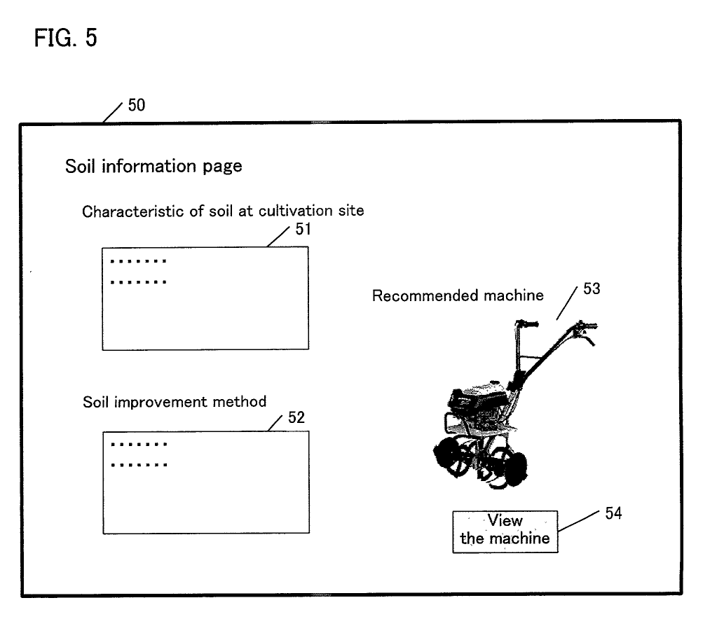

FIG. 5 illustrates an example of the soil information page 50. When the soil information button 34 is clicked in FIG. 3, the server 10 uses the above-retrieved information on the latitude/longitude to retrieve from the soil database 17, information on the soil characteristics for the area of that latitude/longitude. Besides, the server 10 retrieves information on the soil improvement method corresponding to the retrieved soil characteristics from the soil database 17. The retrieved information is transmitted to the user terminal together with the page 50. The information on the soil characteristics is displayed in the field 51 of the page 50 and information on the soil improvement method is displayed in the field 52 of the page 50. The soil characteristic information includes such characteristics of the soil for the concerned area as acidity or alkalinity, humid receptivity and drainage. The soil improvement method information includes how to neutralize the soil characteristics, how to improve the drainage, information on materials and machines appropriate for improving the soil and how to use those materials and machines.

The soil database 17 may additionally store image files of the farm tractors appropriate for the soil improvement works in association with information on the soil improvement methods. In such way, when information on the soil improvement method is retrieved, the associated image file is retrieved at the same time from the soil database 17, and then transmitted to the user terminal so as to be displayed in the field 53 of the page 50.

If the user wants to buy the displayed farm tractor or wants to know in more detail about the displayed farm tractor, the user will be able to move to a farm tractor introduction page (will be explained later) by means of clicking a button 54 displayed beneath the field 53.

Thus, the user could know the soil characteristics of the cultivation place and the related soil improvement method without professional knowledge. Thus, the harvest amount of the crops could be increased through the proper selection for the cultivated crops and the related soil improvement.

When the user clicks the button 43 in FIG. 4 or the button 54 in FIG. 5, information on the farm tractor that is being displayed in the field is transmitted from the user terminal to the server 10 according to the HTTP protocol. The server 10 uses the transmitted information to retrieve from the farm tractor database 19, information on the corresponding farm tractors and the associated image files for the farm tractors. The retrieved information and image files are transmitted along with the farm tractor introduction page to the user terminal.

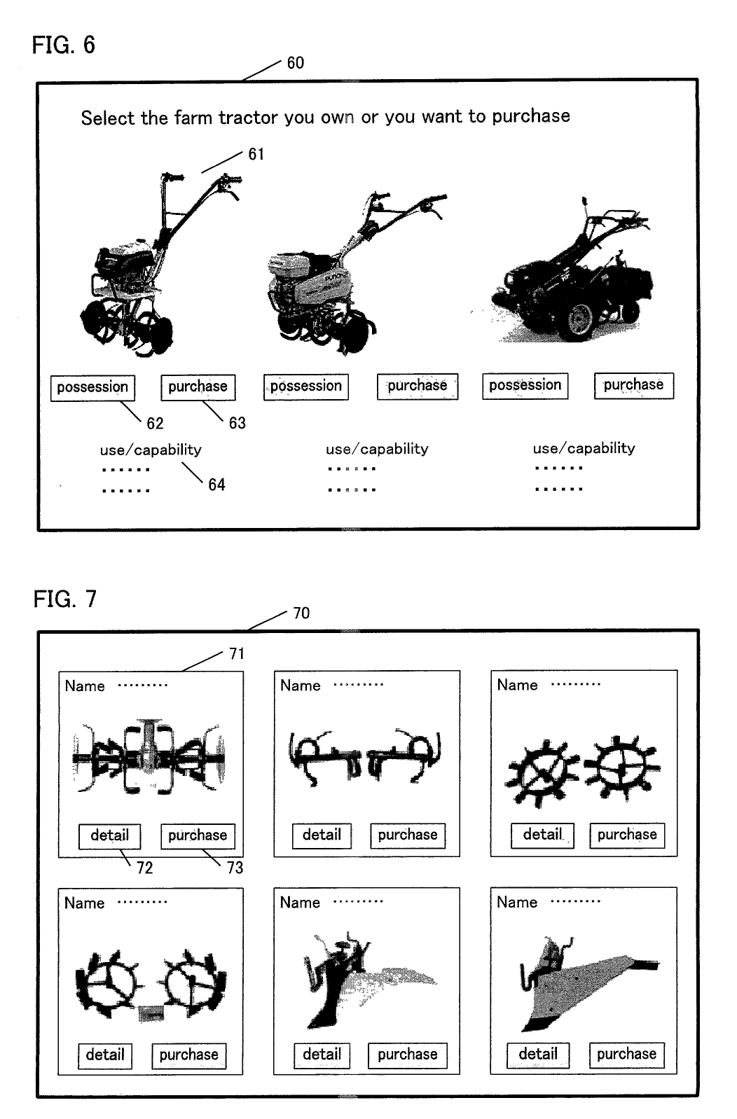

FIG. 6 illustrates an example of the farm tractor introduction page 60. The transmitted image files of the farm tractors are displayed in the fields 61. The information about the farm tractors is displayed in the field 64. When there are many farm tractors that are appropriate for the crop cultivation or for the soil improvement work, the image files for up to three farm tractors and the related information are displayed from left to right. When the user is already in possession of any of the displayed farm tractors and only wants to purchase its attachments, the user clicks the possession button 62 beneath the image of the concerned farm tractor. When the user wants to purchase any of the displayed farm tractors, the user clicks the purchase button 63 beneath the image of the concerned farm tractor. In either case, information on the clicked farm tractor name is transmitted from the user terminal to the server 10 according to the HTTP protocol.

The server 10 retrieves information on the attachments that can be mounted on the concerned farm tractor and the associated image files from the farm tractor database 19, and then transmits the retrieved information and the image files together with the attachment selection page to the user terminal.

FIG. 7 illustrates an example of the attachment selection page 70. The transmitted attachments are displayed in the field 71. When there are many transmitted image files, up to six image files are displayed. When the user clicks a detail button 72 being displayed beneath each attachment image, a box for displaying information on the corresponding transmitted attachment is presented near the detail button 72. The attachment information includes explanation about the work that can be done using the concerned attachment, kinds of the crops or the characteristics of the soil which can be processed with the concerned attachment and so on. Thus, the user could know not only the combination of the farm tractor and the attachments to be required for the crop cultivation and the work but also the use method without any professional knowledge.

When the user wants to buy any attachment that the user does not own, the user clicks a purchase button 63. The information on the clicked attachment name is transmitted from the user terminal to the server according to the HTTP protocol.

The server 10 uses the transmitted attachment name information along with information on the selected and transmitted farm tractor name in the farm tractor introduction page as shown in FIG. 6 to retrieve the price information about the concerned farm tractor and its attachments from the farm tractor database 19. The retrieved price information is stored in the server's memory and subsequently the purchase information input form is transmitted to the user terminal.

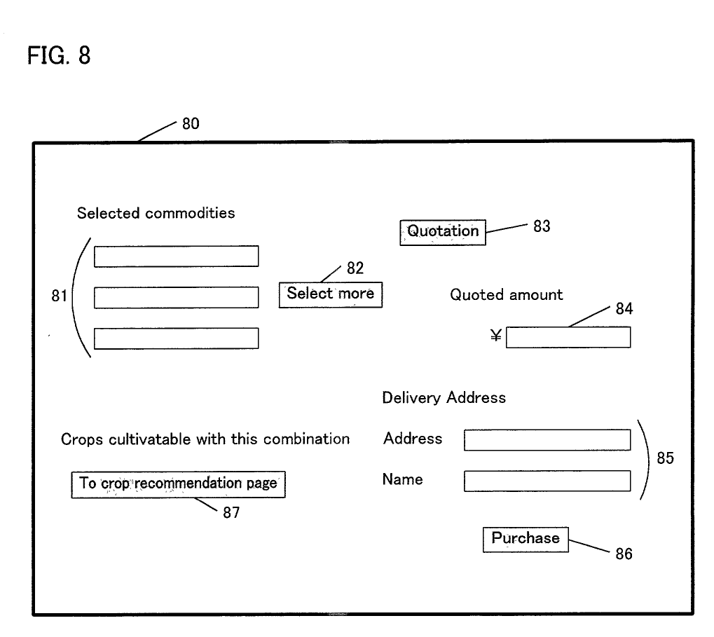

FIG. 8 illustrates an example of the purchase information input form 80. The names of the selected farm tractor and attachments are displayed in the field 81. When the user has clicked the possession button 62 in the farm tractor introduction form in FIG. 6, the name of the farm tractor is not presented in the field 81. If the use wants to purchase a plurality of attachments, the user may click a “select more” button 82, so that the user could return to the attachment selection page 70. When another attachment is selected and clicked in the attachment selection page 70, the same procedure as above-mentioned is repeated. That is, the price information about the selected attachment is retrieved from the farm tractor database 19, the retrieved price information is stored in the server's memory and the name of the newly selected attachment is displayed below the name of the already-selected attachment in the field 81 of the form 80. By repeating the same procedures, all of the required attachments could be displayed in the field 81.

Once the desired commodities have been all displayed in the field 81, the user clicks a price quotation button 83. In response, the server 10 reads out unit prices for the selected farm tractor and attachments from the memory and calculates the total amount. When a plurality of the farm tractors and/or attachments are selected, a certain discounting upon the total amount may be applied in accordance with the predetermined algorithm. The calculated total amount is transmitted to the user terminal and displayed in the field 84 of the form 80. If the user fill-in the address and the name in the field 85 and clicks a purchase button 86, such information is transmitted from the user terminal to the server 10 according to the HTTP protocol. The server transmits such information to the terminal at the sales store via Internet 11.

Thus, users could easily purchase farm tractors and attachments required for their crop cultivation and works using the Internet.

In accordance with another embodiment of the invention, users could select farm tractors and attachments prior to selection of crops to be cultivated. That is, if a user first inputs a URL to access the farm tractor information page, the server 10 retrieves information on an appropriate number of farm tractors and the associated image files from the farm tractor database 19 and then transmits them to the user terminal together with the farm tractor introduction page shown in FIG. 6. When the user clicks to select a specific farm tractor that the user already owns or wants to purchase on the farm tractor introduction page 60 being displayed in the browser of the user terminal, the attachment selection page 70 as shown in FIG. 7 is displayed in the browser of the user terminal so as to present image files of the attachments that can be mounted on the selected farm tractor according to the aforementioned procedure. When the user selects a specific attachment that the user already owns or wants to purchase on the attachment selection page 70, the purchase information input form 80 of FIG. 8 is displayed in the browser at the user terminal and the names of the selected farm tractor and attachment are displayed in field 81.

In this embodiment, when the user clicks a crop recommendation button 87 provided in the page, the server transmits the input form 20 shown in FIG. 2. When the user selects the cultivation area and the cultivation time according to the aforementioned procedure, the crops which can be cultivated in terms of the combination of the selected farm tractor and the attachments will be retrieved among the cultivatable crops in the crop database 16 and displayed on the crop recommendation page 30 shown in FIG. 3.

Thus, the user could know the crops that the user can cultivate through use of the farm tractor and its attachments which the user owns or wants to purchase.

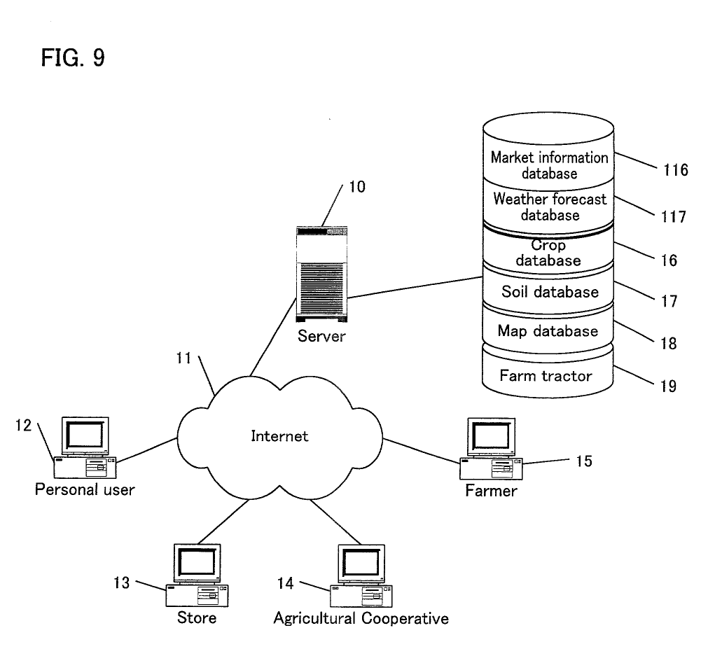

Now, a further embodiment in accordance with the invention will be below explained. FIG. 9 is a general block diagram of a system structure according to another embodiment of the invention. Server 10 is connected to Internet 11 and is configured to provide, over Internet 11, an agriculture product market information page for displaying the market information for the agriculture products, a crop recommendation page for providing information on the crops that are appropriate for the cultivation area and a farm tractor selection page for providing information on the farm tractors and the attachments which are mounted on each of the farm tractors. Terminals 12, 13, 14, 15 are installed respectively at such user places as homes, agricultural machine stores, farmer cooperatives, farmers and so on. Each terminal comprises a display enabling the GUI environment as well as such input device as mouse. Each of the terminals 12, 13, 14, 15 is configured to have a browser that is set up to connect to Internet 11 so as to be able to access the agriculture product market information page, the crop recommendation web site and the farm tractor selection page provided by the server 10 by means of a URL input.

To the server 10, a market information database 116, a weather forecast database 117, a crop database 16, a soil database 17, a map database 18 and a farm tractor database 19 are connected.

The market information database 116 stores beforehand the historical information about the price and the shipment volume for each of the agriculture products in the leading markets throughout the country. The information may be updated at a certain interval, for example, every month. The database also stores the price forecast for each product that is forecasted by the expert.

The weather forecast database 117 stores beforehand information on the long-term weather forecast for each of the primary cities throughout the country. The information may be updated at a certain interval, for example, every month.

The crop database 16, the soil database 17, the map database 18 and the farm tractor database 19 have been above explained in conjunction with FIG. 1.

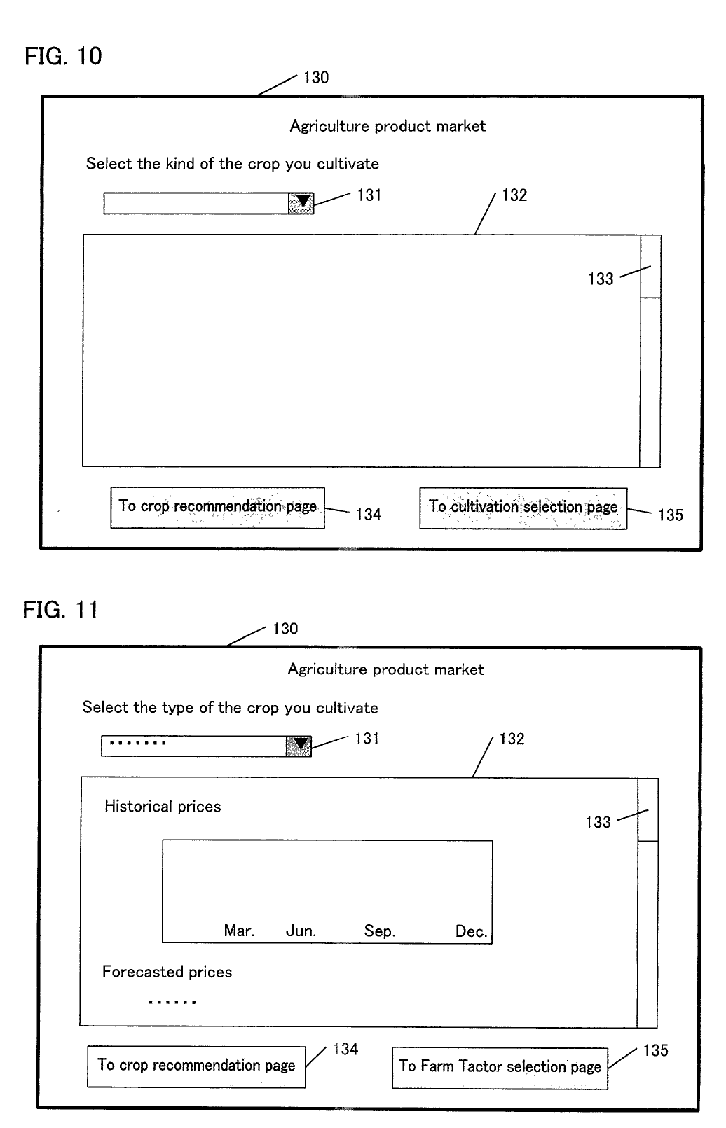

FIG. 10 illustrates an example of the agriculture product market information page 130. The page 130 is designed to include a pull-down menu 131 for selecting an agriculture product, a field 132 for displaying the market information, a button 134 in which a link to the crop recommendation page is embedded and a button 135 in which a link to the farm tractor selection page is embedded. When the user moves the pointer to the triangle mark on the right end of the pull-down menu 131 and clicks thereon by means of the mouse, a list of the agriculture products about which the market information is currently stored in the market information database is displayed below the pull-down menu 131. When the user selects and clicks a product, among the displayed products, which the user wants to know about the market information, the search program of the server 10 is activated in response to that event.

FIG. 11 illustrates the page 130 after the farm product has been selected. The search program retrieves the price information, the shipment volume information and the price forecast information corresponding to the user-selected product from the market information database 116. The search program also retrieves the long-term weather forecast information that has been most recently updated from the weather forecast database 117. Furthermore, the search program creates a historical price graph and a historical shipment volume graph showing months in the respective horizontal axis based on the retrieved price information and the retrieved shipment volume information. The created graphs, the price forecast information and the long-term weather forecast information are transmitted to the user terminal so as to be displayed in the field 132. In the field 132 of FIG. 11, the historical price graph and the price forecast are displayed. When the user moves the pointer onto the square portion 133 of FIG. 11 and move the mouse downward while keeping the mouse button pushed down, the field 132 is scrolled such that other information that has been transmitted to the user terminal is displayed in the field 132. Thus, the user could easily obtain the information about product prices, shipment volumes and weather forecast through the home terminal, which is very helpful for the user to make a revenue/expenditure plan for cultivating crops.

When the user clicks a button 134 in FIG. 11, the crop recommendation page appears. The function of this page has been above explained in conjunction with FIG. 2 through FIG. 5. When the user clicks a button 135, the farm tractor selection page appears. The function of this page has been above explained in conjunction with FIG. 6 through FIG. 8.

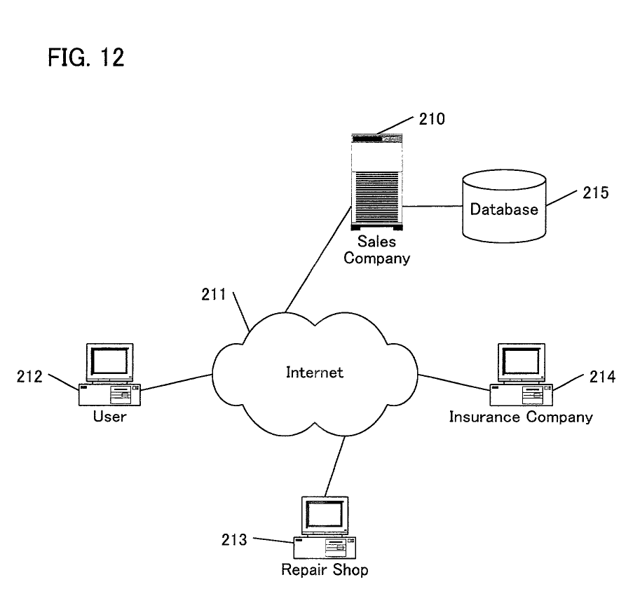

FIG. 12 is a general block diagram of a system structure according to a further embodiment of the invention. Server 210 is constructed as a computer system, which comprises a database 215. The server 210 is installed at, for example, an agricultural machine selling company in order to provide a web site for presenting the repair center information over Internet 211. A terminal 212 at a user owing an agricultural machine, a terminal 213 at a repair center and a terminal 214 at an insurance company handling repairing insurances are installed respectively. Terminals 212, 213, 214 are typically personal computers, but may be any of portable terminals or mobile telephones that can be used through Internet. Each terminal comprises such display means as display as well as such input device as keyboard and mouse so as to enable the GUI environment. Each of the terminals 212, 213, 214 is configured to use a browser so as to be able to transmit/receive HTML documents between the server 210.

The database 215 stores beforehand map image files and repair center information. The map image files include maps that are classified into certain regions, for example, towns, which can be retrieved by the name of the region or town. Coordinates are set in each image file, so that the user can obtain the coordinate of the desired place by means of moving the pointer to the desired place within the map. The repair center information includes names and locations of repair centers, types of the agricultural machines handled by each repair center, operational hours, service charge, trip charge and coordinate in the map image file regarding the locations of the repair centers.

In this embodiment, the agricultural machine selling company also plays a roll for an agent for the insurance company and is allowed to make contracts upon repairing insurances with users. In another embodiment, the invention can be constructed such that the insurance company may directly make contracts with users rather than through agents, or a repair center may be an agent for the insurance company.

The user uses the browser at the terminal 212 to access the web site provided by the server 210 of the agricultural machine selling company. The web site includes a page for introducing repair centers. This page includes guidance information for the repairing insurance in addition to the repair center information. This page also comprises a button for requesting the application form for the repairing insurance. Upon receiving an event of the user's clicking upon this button, the server 210 transmits the user information input form to the user terminal 212.

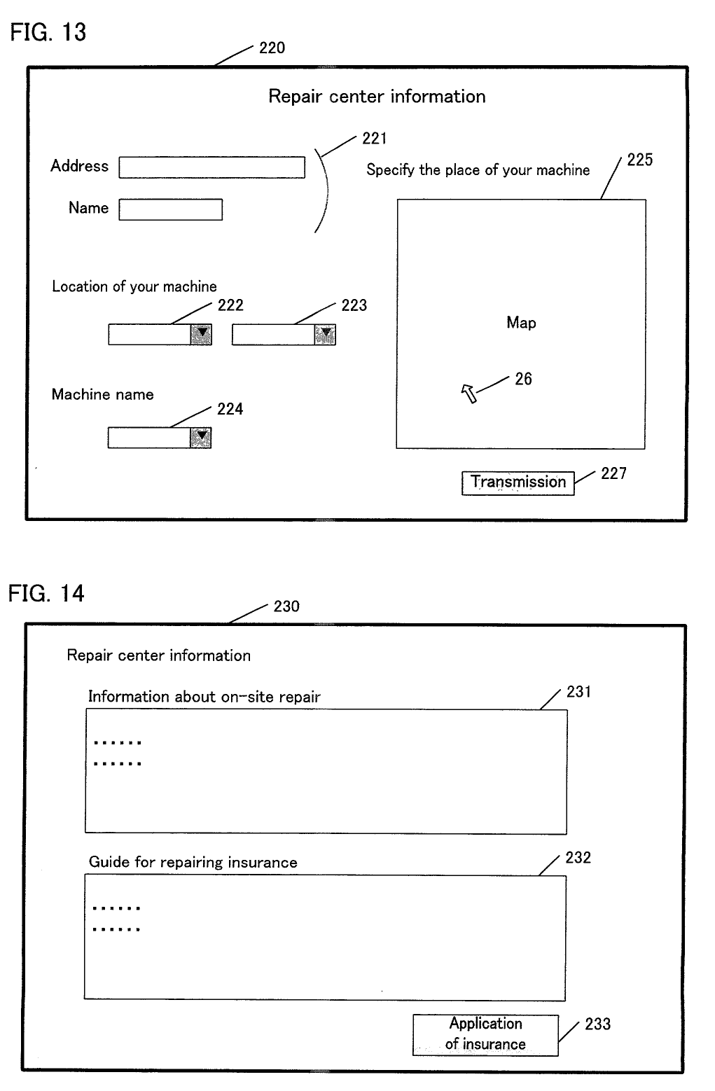

FIG. 13 illustrates an example of the input form 220 that is displayed on the display at the user terminal 212. The input form 220 comprises an input field 221 for the name and address of the user, a district pull-down menu 222 and a town pull-down menu 223 for displaying map image files for the user to select the place where the user's cultivating machine is located, a machine name pull-down menu 224 for selecting the machine name, a field 225 for displaying a map image file and a transmission button 227. Besides, a pointer 226 is displayed on the display screen.

After having input the name and address in the field 221, the user uses the pull-down menus 222, 223 to select the place where the concerned machine is located. Specifically, the user first moves the pointer 226 onto the triangle mark on the right end of the pull-down menu 222 and clicks thereon by means of the mouse, so that a window for displaying district names appears beneath the pull-down menu 222. The user moves the pointer 226 onto the name of the district name covering the machine location and clicks thereon to select the district. Subsequently, the user moves the pointer 226 onto the triangle mark on the right end of the pull-down menu 223 and clicks thereon, so that a window for displaying names of the towns within the above-selected district appears beneath the pull-down menu 223. When the user moves the pointer 226 onto the town name covering the machine location and clicks thereon, the town name information is transmitted to the server 210 according to the HTTP protocol.

The server 210 retrieves the map image file corresponding to the selected town name from the database 215 based on the transmitted information and transmit it to the user terminal 212. The map image file transmitted to the user terminal 212 is displayed in the field 225. Coordinates are set in the map image files as aforementioned. When the user moves the pointer 226 onto the point on the map image file corresponding to the place where the user machine is located and clicks thereon, the coordinate for that point is obtained by the browser. When the user further moves the pointer onto the triangle mark on the right end of the pull-down-menu 224 and clicks thereon, a window displaying types of the agricultural machine is displayed below the pull-down menu 224. Then the user clicks to select the type of the machine to be repaired from the displayed machine type list. Finally, when the user clicks the transmission button 227, the coordinate information of the location for the purchased machine and the machine type information are transmitted to the server 210 according to the HTTP protocol.

The server 210 determines the most appropriate repair center based on the transmitted information. More specifically, the server 210 first calculates a straight distance between the coordinate of the transmitted user machine location and the coordinate of each of the candidate repair centers retrieved from the database. In order to determine a repair center most convenient to the user machine location, the candidate repair center closest (in terms of such calculated strait distance) to the user machine location is first examined whether that candidate repair center is capable to perform a repair upon the transmitted machine type. If not, the next closest repair center is examined. In such way, the repair center that is closest to the user machine location and also capable to repair the concerned machine type is eventually determined as most appropriate. The information on the determined repair center is transmitted to the user terminal 212. The transmitted repair center information is displayed in the repair center information page.

FIG. 14 illustrates an example of the repair center information page 230. The repair center information is displayed in the field 231. The repair center information includes name and address of each repair center and guidance for operation hours, repairing and trip charges. The information about the repairing insurance is displayed in the field 232. The repairing insurance is, as aforementioned, to allow the user to receive the on-site repairing service by the repairing service agent with lower cost or even free charge if the user pays a certain premium. The repairing insurance information includes an outline of the insurance, terms and conditions, premium amount, insurance companies offering the insurance and so on. When the user wants to sign-up the repairing insurance after having read the repairing insurance information, the user may click a button 233 for requesting the application form for the repairing insurance.

When the user wants to sign-up the repairing insurance and clicks the button 233, the server 233 transmits the application form that is linked with the button 233 to the user terminal 212.

In the application form, respective input fields for inputting the items required for the insurance contract such as the name and address of the user and the registration number of the agricultural machine are displayed in addition to the contract content. A button is also provided for transmitting the application form to the server 210.

After having filled in the required items in the fields, the user clicks the transmission button to transmit information on the contract items to the server 210 installed at the agricultural machine selling company according to the HTTM protocol.

In an embodiment in which the insurance company directly makes an insurance contract with the user rather than through the agent, the server 210 transmits information on the contract items to the terminal 214 installed at the insurance company. In a further embodiment in which the repair center is an agent for the insurance company, the server 210 transmits information on the contract items to the terminal 213 installed at the repair center that has introduced the insurance to the user.

In this embodiment, after the repairing insurance has become effective, as long as the user pays a certain premium amount, the user could receive the on-site repairing service by the repairing service agent with lower or free charge whenever the on-site repair becomes required due to occurrence of some trouble of the agricultural machine the user owns.

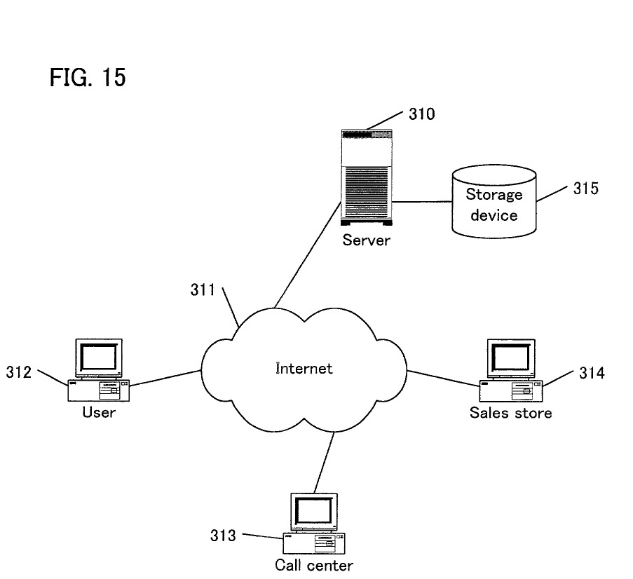

FIG. 15 is a general block diagram of a system structure according to yet another embodiment of the invention. Server 310 is constructed as a computer system and connected to a storage device 315. The server 310 is installed at a virtual store operating company who provides a virtual store web site on Internet 311 for presenting the information about goods and services. The storage device 315 includes a user database for storing the information about the users who have used the web site as well as a sales store database for storing the information about sales stores.

The user who makes an access the web site over the Internet has a terminal 312 installed at the user side. Another terminal 313 is installed at a call center that is responsible for taking care of users who are viewing the web site to explain the goods and services to such users. Another terminal 314 is installed at a sales store that performs selling and/or after-service directly to users. Although FIG. 15 shows only one terminal 312, 313 and 314 at each location for the purpose of the simple illustration, more than one terminal may be installed at each side depending on the embodiments. Terminals 312, 313, 314 are typically personal computers, but may be any of portable terminals or mobile telephones that can be used through the Internet. Each of these terminals comprises input means such as keyboard and mouse, display means such as display, communication means such as speakers and microphones and/or head-cassettes, a soundboard and a modem. Each terminal is connected to Internet 311 and configured to be capable to receive/transmit HTML documents from/to the server 310 through use of the browser.

Besides, Internet telephone software is installed at terminals 312, 313, 314. The Internet telephone software is configured such that either user or server 310 can activate it. When the Internet telephone software is activated and a telephone number is input, a message indicating a telephone call occurrence is displayed on the display screen of the terminal that is connected to the corresponding telephone line. Once the telephone communication has been established, the voice of the speech that is talked on the microphone connected to the terminal is converted to the digital signal through the soundboard and transmitted via modem. The signal that has been transmitted from the opposite side is converted to the analog signal and output from the speakers as voice.

In accordance with another embodiment, the user can make a usual telephone call from the user terminal 312 to a usual telephone installed at the call center or the sales store. In this embodiment, a provider utilized by the call center and/or the sales store installs a gateway for converting between the analog sound signal and the digital signal.

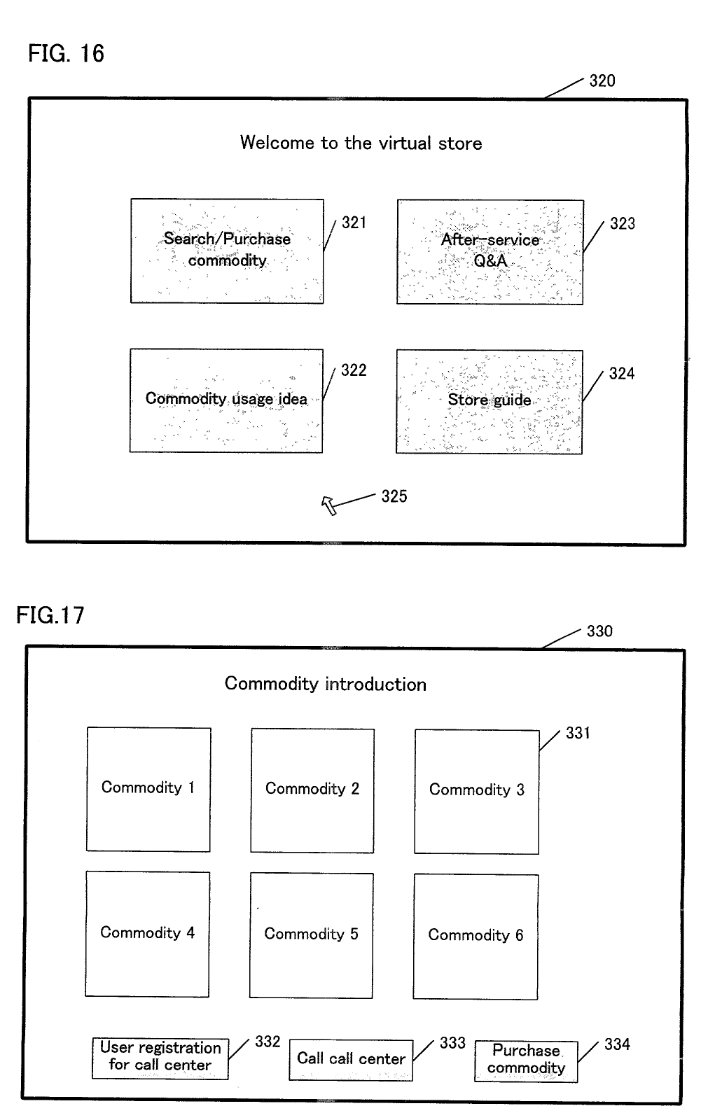

When the user inputs the URL of the virtual store web site from the terminal 312, the server 310 transmits the web site to the user terminal 312. FIG. 16 illustrates an example of the web site 320. The web site 320 comprises a button 321 to which a commodity introduction page is linked for presenting the commodity information for the user so as to buy some commodities, a button 322 to which a page is linked for presenting the information about the commodity utilization idea, a button 323 to which a page is linked for presenting information on the after-service and the usage for commodities and a button 324 to which a store guide page is linked for introducing the stores who are dealing in the concerned commodities. When the commodities which the virtual store web site deals in are, for example, agricultural machines, the information about the commodity utilization idea means such information as crop cultivation methods, and information on the after-service and the usage for commodities means the information about the insurance related with the repair of agricultural machines and/or the usage methods of the attachments to be used with agricultural machines.

A pointer 325 is displayed on the web site. Besides, each of the pages, which will be explained later, also includes an equivalent pointer as the pointer 325 on the display screen although not illustrated in the accompanying drawings. Any button displayed in the browser can be clicked if the mouse button is depressed after such pointer as pointer 325 has been moved to the concerned button displayed in the browser by means of the mouse or the like. Since this button is described by the HTML, clicking the button can be a trigger for requesting the file of the page as a destination of the link stored in the server, transmitting the HTML document including the input information or invoking such server program as CGI program. Besides, if the mouse button is depressed after the pointer has been moved onto an input field displayed in the browser, a cursor for inputting some characters can be displayed in the input field.

When a button 321 is clicked in the web site 320 shown in FIG. 16, the server 310 transmits the commodity introduction page to the user terminal. In the following explanation, the commodity introduction page will be referred to as an exemplary for the purpose of describing the operation of the system of the invention. It should be noted that the basic operations of all other pages linked to buttons 322, 323, 324 are same as the commodity introduction page. Besides, although not shown in the accompanying drawings for each of the below-explained pages, each page in a lower layer than the web site is configured to be able to freely return to the web site.

FIG. 17 illustrates an example of the commodity introduction page 330. The information on the commodities offered by the virtual store is displayed together with their images in fields 331 of the commodity introduction page 330. The commodity introduction page 330 also includes a button 332 for displaying a form for the registration of the users for using the call center, a button 333 for displaying a form where a user ID for calling the call center can be input and a button 334 for purchasing the displayed commodity.

If it is the first time for a user to make use of the call center, the user clicks the button 332 to request the server 310 to transmit the user registration form. When a user already has a registered user ID, the user clicks the button 333 to request the server 310 to transmit the user ID input form. In response, the server 310 transmits the requested form to the user terminal 312. When the user input the user ID in the transmitted form, the user can utilize the call center.

When the user wants to purchase one of the displayed commodities, the user clicks the button 333 to request the server 310 to transmit the purchase input form. In response, the server 310 transmits to the user terminal 312 the input form, which comprises some fields for inputting name, address and product number of the wanted commodity as well as a transmission button. The user inputs the required items and clicks the transmission button. Then, the input information is transmitted to the server 310. Thus, the user could purchase the desired commodity.

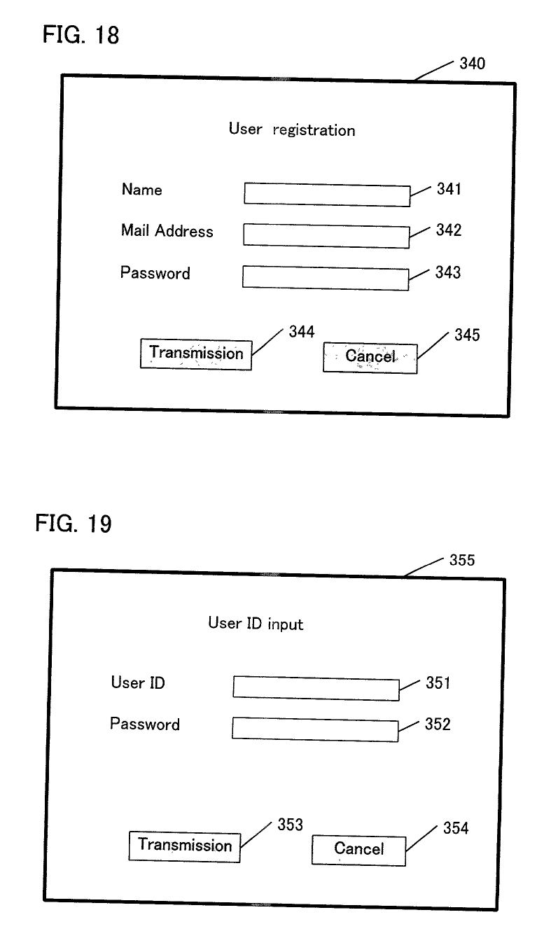

FIG. 18 illustrates an example of the user registration form 340. The user registration form 340 includes a field 341 for inputting the user name, a field 342 for inputting the mail address, a field 343 for inputting a password the user desires, a transmission button 344 for transmitting the input information to the server 310 and a cancel button 345 for canceling the input information to return the commodity introduction page.

When the user inputs the required items to the fields 341, 342, 343 and clicks the transmission button 344, the input information is transmitted to the server 310. In response, the server 310 determines a user ID that is unique to each user. Then, the determined user ID and the user-input name, mail address and password are stored in the user database in the storage device 315. At the same time, the server 310 transmits the determined user ID to the user terminal 312. A new page is opened in the browser so that the transmitted user ID can be displayed at the user terminal 312. Alternatively, the user ID may be notified through a mail to the user mail address that has been stored in the user database.

FIG. 19 illustrates an example of the user ID input form 350 for the user who has already obtained the registered user ID. The user ID input form 350 includes a field 351 for inputting the user ID, a field 352 for inputting the password, a transmission button 353 for transmitting the input information to the server 310 and a cancel button 354 for canceling the input information to return the commodity introduction page.

When the user inputs the required items to the fields 351, 352 and clicks the transmission button 353, the input information is transmitted to the server 310. The server 310 consults the user database to determine whether the combination of the user ID and the password that have been input matches with one of combinations of the registered user name and the corresponding password. When there is no matching combination, a message prompting the user to retry the input is displayed in the browser at the user terminal 312. When there is a matching combination, the server 310 activates the Internet telephone software installed at the user terminal 312 and also transmits the information about the telephone number of the call center to the user terminal 312.

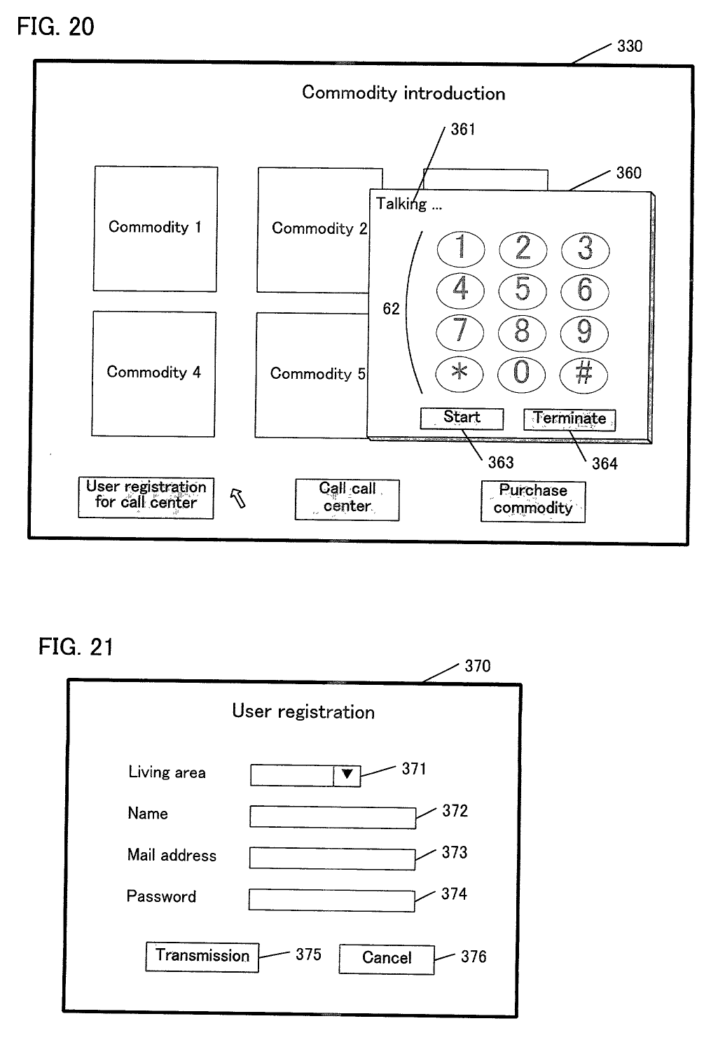

The Internet telephone software is displayed at the user terminal 312 by means of, for example, such window 360 as shown in FIG. 20. The window 360 includes a region 361 for displaying the transmission status, numeral buttons 362, a start button 363 for starting the telephone conversation and a termination button 364 for terminating the telephone conversation.

The Internet telephone software is configured in such way that if the user clicks some numeral buttons corresponding to the telephone number in sequence just in the same manner as for the usual push type telephone and then clicks the start button 363, the user can talk with the terminal connected to the telephone line having the corresponding telephone number through the microphone and speakers. The Internet telephone software is further configured to use information on the transmitted telephone number to automatically make a call to that telephone number. The Internet telephone software is configured to automatically display, in the region 361, a message notifying that the telephone call has been received. When the start button 363 is clicked in response to that message, the communication is established, so that the conversation becomes possible.

In the call center, a plurality of terminals 313 are installed. At each terminal, the Internet telephone software is installed and an operator is disposed.

In this embodiment, the Internet telephone software at the user terminal 312 automatically makes a telephone call via modem to the telephone number of the call center that is transmitted from the server 310. An operator in the call center responds to that call using the terminal 313. In such way, the user can receive the explanation about the commodity or how to use the web site from the operator or ask the purchasing process to the operator while the user is looking at the commodity displayed on the display screen at the terminal 312. Thus, the user can select the commodity with a feeling as if the user were visiting the real store.

Another embodiment is constructed such that whenever the user makes a phone call to the call center, the connection should be always established to the terminal 213 of the same operator who has responded previously. In this embodiment, the terminal 313 for each operator in the call center is assigned a different, unique telephone number. When the server 310 processes the user ID registration, it selects a telephone number of an operator at random, stores the selected telephone number together with the associated user ID in the user database and transmits that telephone number to the user terminal 312. When the user inputs the user ID for calling the call center at the next time, the server 310 retrieves the telephone number of the operator terminal 313 associated with the user ID from the user database and transmits it to the user terminal 312. Thus, the user can always communicate the same operator whenever the user makes an access the virtual store web site. Thus, the user can utilize the web site comfortably.

As aforementioned, each page is configured to freely move back and forth between the web site. Therefore, the user can communicate with the operator about the contents of not only the commodity but also the idea for the use of the purchased commodity and the after-service. In either case, the user can receive the verbal explanation while view the information displayed on the display screen, and accordingly the user can understand the commodity much better, which leads to higher user satisfaction.

Besides, a further embodiment of the invention is constructed in such a manner that the user can use the Internet telephone software to communicate with a real salesperson working at a real store. In this embodiment, the sales store database includes coverage and location of each store, names and telephone numbers of the salespersons belonging to the store, characteristics of the store. Besides, image files of the view of each store and image files of photos of the faces associated with salesperson's names are stored in the sales store database.

In this embodiment, each salesperson belonging to a store is provided with an individual terminal 314, which is connected to a different, unique telephone line.

FIG. 21 illustrates an example of the user registration form 370 to be used in this embodiment. When the user clicks the user registration button 332 of the commodity introduction page 330 in FIG. 17, the server 310 transmits the user registration form 370 to the user terminal 312. The user registration form 370 includes a pull-down menu 371 for selecting the area where the user is living, a field 372 for inputting the user name, a field 373 for inputting the mail address, a field 374 for inputting a password the user desires, a transmission button 375 for transmitting the input information to the server 310 and a cancel button 376 for canceling the input information to return the commodity introduction page.

When the user clicks the triangle mark at the right end of the pull-down menu 371, a window for displaying the district names is extended beneath the pull-down menu 371. Instead of the district, any classification for the area may be used as long as it corresponds to the coverage classification of the stores recorded in the sales store database. When the user further inputs the required items to the fields 372, 373, 374 and clicks the transmission button 344, the input information is transmitted to the server 310.

In response, the server 310 stores the transmitted information in the user database, determines a user ID and transmits it to the user terminal 312. This process is same as that in the aforementioned embodiment. The server 310 further retrieves from the sales store database information on the store covering the area that has been input by the user. The retrieved information is transmitted to the user terminal 312. The transmitted information is displayed as the store introduction page on the display of the user terminal 312.

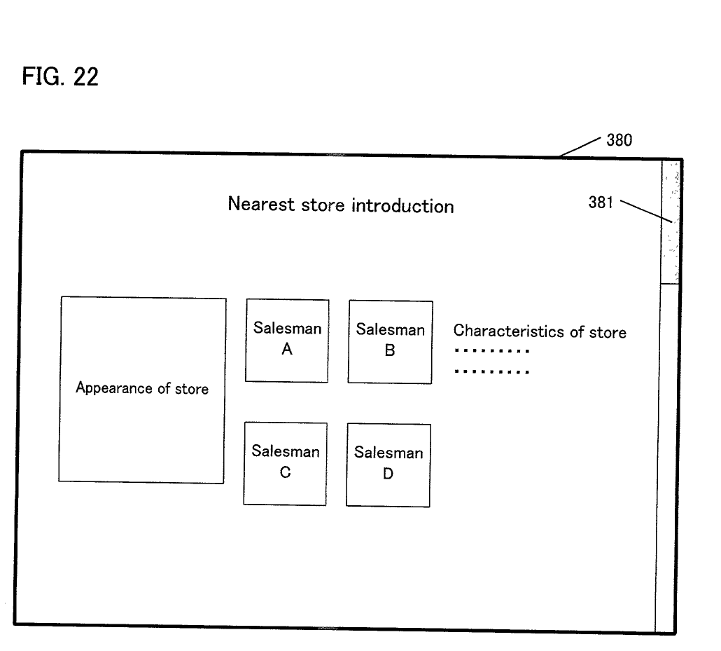

FIG. 22 is an example of the store introduction page 380. As shown there, the store information includes a view of the store, photographs and names of salespersons and store characteristics. FIG. 22 illustrates the information about only one store. When there are more than one stores that have been retrieved, the user can look through the information about all store if the user moves the pointer to the scroll bar displayed at the right end of the page and then drags the pointer downward or upward while keeping the mouse button pushed down.

The user reads the displayed information and selects a desired salesperson of a store with which the user wants to deal. A link is set up on the image of the salesperson. When the user moves the pointer to the image and clicks thereon, information on the selected salesperson is transmitted to the sever 310.

The server 310 retrieves the telephone number information corresponding to the transmitted salesperson information from the sales store database and transmits it to the user terminal 312. Thereafter, according to the same procedure as aforementioned in conjunction with the call center, a communication between the user terminal 312 and the salesperson's terminal 314 at the store is established. The user can talk with the salesperson while seeing the information displayed on the display screen in the terminal 312.

During such communication, either the image of the speaking salesperson or an attractive animation character may be displayed. As for the animation character, the server 310 transmits such program as Java applet to the user terminal 312. The browser at the user terminal 312 processes the transmitted program to display the animation. In another embodiment, the Internet telephone software is not limited to the voice communication. The invention may be constructed in such a manner that each of the terminals at the user, the call center and the store is provided with the respective CCD camera so as to transmit motion pictures in real time during the telephone conversation.

In the same manner as in the embodiment described above in conjunction with the call center, the invention may be constructed such that the same terminal 314 of the salesperson with whom the user has previously talked should be always called. With such structure, the user can always talk with the same salesperson when the user accesses the virtual store web site. Accordingly, the user may feel intimate with the salesperson and can select the commodity comfortably. Furthermore, when the user visits the real store, the user also feels comfortable if the user meets the same salesperson that the user has talked with over the web site.

What is claimed is:

1. A system for recommending cultivated crops, comprising:
a crop database for storing information on the crops that are appropriate for cultivation in terms of cultivation areas and cultivation seasons; and
a server for providing over the Internet a web site that is associated with the crop database,
wherein the server is configured, in response to a user's access the web site, to transmit an input form to the user so as to allow the user to input the user's crop cultivation area and the cultivation season in the input form, to retrieve the crop information from the crop database based on the information in the filled-in form transmitted back from the user, and to transmit the retrieved crop information to the user.

2. The system according to claim 1, further comprising a soil database for storing information about soil characteristics and soil improvement methods for each area,
wherein the server is configured to retrieve the information about soil characteristics and soil improvement methods from the soil database based on the information in the filled-in form transmitted back from the user, and to transmit the retrieved soil information together with the crop information to the user.

3. The system according to claim 2, further comprising a map database for storing map images for each area together with information on latitudes/longitudes,
wherein the server is configured to retrieve from the map database a map image covering the user's crop cultivation area that is included in the information in the filled-in input form transmitted back from the user, transmit the retrieved map image to the user, to read out the latitude/longitude information on a place from the map database in response to an event that the user moves a cursor onto the place on the map and clicks there, and to search through the crop database and the soil database based on the latitude/longitude information.

4. The system according to claim 2, further comprising a map database for storing images of railroad maps for each area together with information on latitudes/longitudes for stations included in the railroad maps,
wherein the server is configured to retrieve from the map database a railroad map image covering the user's cultivation area that is included in the information in the filled-in input form transmitted back from the user, to transmit the retrieved railroad map image to the user, to read out the latitude/longitude information of a station from the map database in response to an event that the user moves a cursor onto the station displayed on the railroad map and clicks there, and to search through the crop database and the soil database based on the latitude/longitude information.

5. A system for recommending farm tractor attachments, comprising:
a farm tractor database for storing information on farm tractors that are appropriate for each crop to be cultivated as well as information on attachments to be mounted on the farm tractors; and
a server for providing over the Internet a web site that is associated with the farm tractor database,
wherein the server is configured, in response to a user's access the web site, to transmit to the user a page for displaying the farm tractor information retrieved from the farm tractor database and for displaying a button having a link capability, to retrieve information on attachments from the farm tractor database in response to an event that the user moves a cursor onto the button and clicks there, and to transmit the retrieved information to the user.

6. The system according to claim 5, further comprising a crop database for storing information on the crops that are appropriate for cultivation in terms of cultivation areas and cultivation seasons,
wherein the server is configured, in response to a user's access the web site, to transmit an input form to the user so as to allow the user to input the user's crop cultivation area and the cultivation season, to retrieve the crop information from the crop database based on the information in the filled-in input form transmitted back from the user, and to search through the farm tractor database based on the retrieved crop information.

7. A system for supporting cultivation of crops, comprising:
a market database for storing information on historical prices and shipment volumes regarding crops; and
a server for providing over the Internet a page, which is associated with the market database, for allowing for selection of crop names,
wherein the server is configured to transmit the page to a user in response to the user's access, to search on the market database in response to an event of the user's clicking operation upon a crop name being displayed on the page, and to transmit to the user information on historical price and shipment volume corresponding to the clicked crop in a form of HTML document.

8. The system according to claim 7, further comprising a weather forecast database for storing information on long-term weather forecast,
wherein the server is configured to search through the weather forecast database in response to the event of the user's clicking operation upon a crop name and transmits the long-term weather forecast information to the user in a format of HTML document.

9. The system according to claim 7, further comprising a crop database for storing information on the crops that are appropriate for cultivation in terms of cultivation areas and cultivation seasons,
wherein the server further comprises a crop information page in which a link from the HTML document is embedded, and the server is configured, in response to a user's access the crop information page through the link, to transmit an input form to the user so as to allow the user to input the user's crop cultivation area and the cultivation season, to retrieve the crop information from the crop database based on the information in the filled-in input form transmitted back from the user, and to transmit the retrieved crop information to the user in a forma of HTML document.

10. The system according to claim 7, further comprising a farm tractor database for storing information on the farm tractors that are appropriate for each crop to be cultivated,
wherein the server further comprises a farm tractor information page in which a link from the HTML document is embedded, and the server is configured, in response to a user's access the farm tractor information page through the link, to retrieve the farm tractor information corresponding to the clicked crop from the farm tractor database and to transmit the retrieved farm tractor information to the user in a form of HTML document.

11. A repair center information system comprising;
a database regarding repair centers for agricultural machines; and
a server for providing over the Internet a page regarding repair centers,
wherein the server is configured, in response to a user's access the page, to transmit to the user a first input form for allowing the user to input a location where an agricultural machine owned by the user is located, to retrieve information on the repair center that is located closest, in terms of distance, to the location of the user's machine based on the location information included in the filled-in first input form transmitted back from the user and transmits to the user a HTML document containing information on the repair center and information on the repairing insurance.

12. The system according to claim 11, wherein a button for a user to request an application form about the repairing insurance is embedded in the HTML document, and
wherein the server is configured, in response to the user's clicking operation on the button, to transmit to the user a second input form for allowing the user to input information on the user, and to make a registration of an insurance contract in response to transmission of the filled-in second input form from the user.

13. A virtual store system, comprising:
a user terminal having an Internet telephone capability;
a business entity operator terminal having the Internet telephone capability;
a server providing over the Internet a virtual store web site including a button for establishing a communication between the user and the business entity operator by means of using the Internet telephone capability; and
a storage device containing a first database for storing information on the user and a second database for storing information on the telephone number of the business entity operator terminal,
wherein the server is programmed to retrieve the telephone number information of the business entity operator terminal from the second database in response to the user's operation of clicking the button after the user have accessed to the web site through the user terminal, and to transmit the retrieved telephone number information to the user terminal; and
wherein the user terminal is programmed to use the Internet telephone capability to make a telephone call to the transmitted telephone number.

14. The system according to claim 13, wherein the web site further comprises a second button for allowing the user to make a telephone call again to the same business entity operator to whom the user have called using the Internet telephone capability when the user has previously accessed to the web site;
wherein the first database stores the transmitted telephone number information in association with the user; and
wherein the server is programmed to retrieve from the first database the telephone number information of the business entity operator terminal that is associated with the user in response to the user's operation of clicking the second button after the user has accessed to the web site through the user terminal, and to transmit the retrieved telephone number information to the user terminal.
